(19) United States
(12) Patent Application Publication
(10) Pub. No.: US 2009/0237315 A1
(43) Pub. Date: Sep. 24, 2009

(54) Multi-input, multi-output antenna device

(76) Inventor: Shi-Lin Huang, Jhongli City (TW)

Correspondence Address: TROXELL LAW OFFICE PLLC, 5205 LEESBURG PIKE, SUITE 1404, FALLS CHURCH, VA, 22041, US

(21) Appl. No.: 12/076,607

(22) Filed: Mar. 20, 2008

(51) Int. Cl. H01Q 21/00

(52) U.S. Cl. 343/727

(57) ABSTRACT

The antenna device of the invention mainly comprises a dipole antenna and a slot antenna for receiving and transmitting signals, wherein said slot antenna has at least one metal flat plate of L type section, said metal flat plate is formed with a bending at middle section, two ends of the bending are respectively made to a vertically extended vertical section and a horizontally extended horizontal section, and said metal flat plate is made with a slot which is connected through between vertical and horizontal sections, thereby constituting a multi-input, multi-output antenna device to be able to effectively segregate receiving and transmission frequencies without signal interferences.

### BACKGROUND OF THE INVENTION

(a) Field of the Invention

The invention is related to an improvement on antenna device, more particularly to a multi-input, multi-output antenna applicable to be mounted on electrical appliances for multi-input, multi-output (MIMO) use.

(b) Description of the Prior Art

The multi-input, multi-output (MIMO) technology is a radio transmission technology which is through multiple individually independent antennas to emit signals at the emitting end, and multiple antennas to receive and recover the original message at the receiving end simultaneously. The core technology concept is meant to utilize the space degree of freedoms offered by said multiple emitting antennas and said multiple receiving antennas to effectively promote the spectrum of radio communication system and transmission rate in order to improve the communication quality, so that system data throughput and transmission distance can be greatly increased while without increasing bandwidth or total transmit power expenditure.

An antenna device as shown in FIG. 1A is to be mounted on electrical appliances for multi-input, multi-output technology use, said antenna device mainly comprises two dipole antennas 10 for receiving and transmitting signals respectively, wherein as shown in FIG. 1B, one dipole antenna is represented by a solid line, while the other dipole antenna is represented by a dashed line, whereas said two dipole antennas 10 have the same frequency with small negative values, and further with poor isolation, the signals are easy mutually interfered thereby affecting signal reception quality of the whole antenna and electrical appliances.

### SUMMARY OF THE INVENTION

In view of this, the invention is to improve the aforesaid disclosed conventional antenna device, particularly to provide a multi-input, multi-output antenna device applicable to be mounted on electrical appliances for multi-input, multi-output (MIMO) use.

To achieve above disclosed purpose, the antenna device of the invention mainly comprises a dipole antenna and a slot antenna for receiving and transmitting signals, wherein said slot antenna has at least one metal flat plate of L type section, said metal flat plate is formed with a bending at middle section, two ends of the bending are respectively made to a vertically extended vertical section and a horizontally extended horizontal section, and said metal flat plate is made with a slot which is connected through between vertical and horizontal sections, thereby constituting a multi-input, multi-output antenna device to be able to effectively segregate receiving and transmission frequencies without signal interferences.

### BRIEF DESCRIPTION OF THE DRAWINGS

FIG. 1A is a structural schematic view of a conventional antenna device.

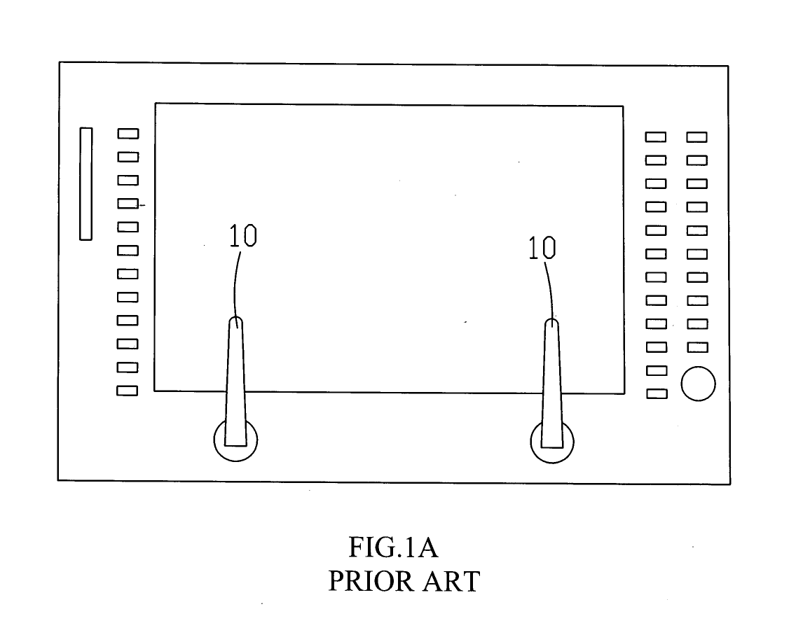

FIG. 1B shows the reflection loss and voltage standing wave ratio (VSWR) of two conventional dipole antennas.

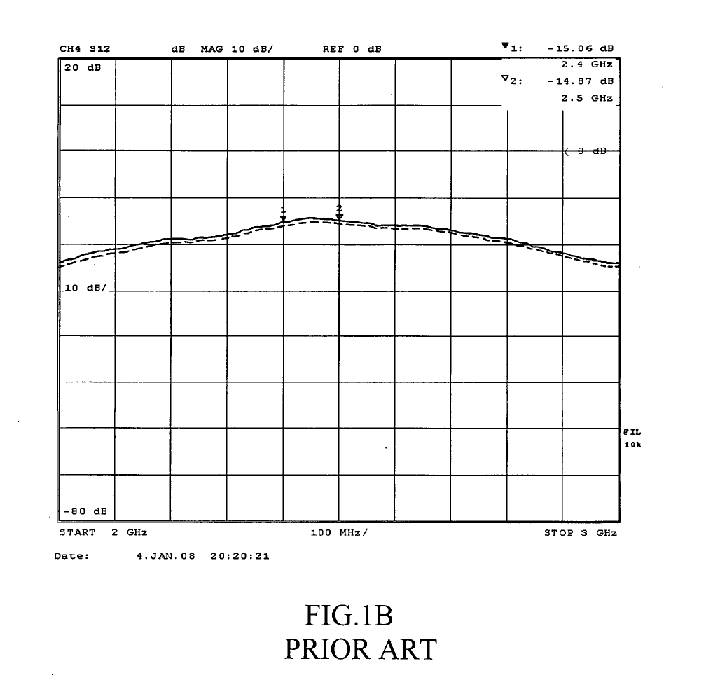

FIG. 2A is a structural schematic view of the antenna device of the invention.

FIG. 2B shows the reflection loss and voltage standing wave ratio (VSWR) of the dipole antenna and slot antenna in the first embodiment of the invention.

FIG. 2C shows the reflection loss and voltage standing wave ratio (VSWR) of the dipole antenna and slot antenna in the second embodiment of the invention.

FIG. 3 is a structural view showing the outlook of the slot antenna in the first embodiment of the invention.

FIG. 4 is a cross-sectional view of the slot antenna in the first embodiment of the invention.

FIG. 5 is another structural view showing the outlook of the slot antenna in the first embodiment of the invention.

FIG. 6 is a structural view showing the outlook of the slot antenna in the second embodiment of the invention

FIG. 7 is a structural decomposition view of the slot antenna in the second embodiment of the invention.

FIG. 8 is a structural cross-sectional view of the slot antenna in the second embodiment of the invention.

FIG. 9 is another structural view showing the outlook of the slot antenna in the second embodiment of the invention.

FIG. 10A shows the radiation field distribution measured at 2.45 GHZ frequency for the slot antenna in the first embodiment of the invention.

FIG. 10B shows the radiation field distribution measured at 2.45 GHZ frequency for the slot antenna in the second embodiment of the invention

### DETAIL DESCRIPTION OF THE PREFERRED EMBODIMENTS

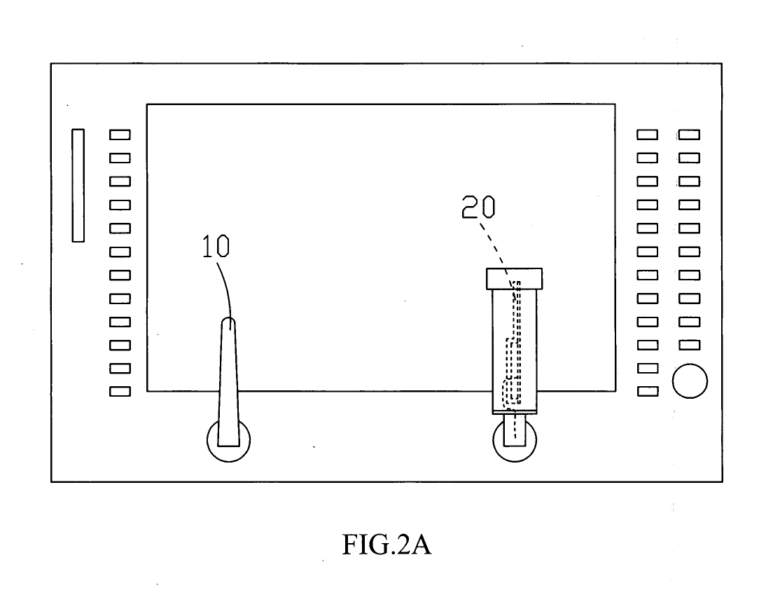

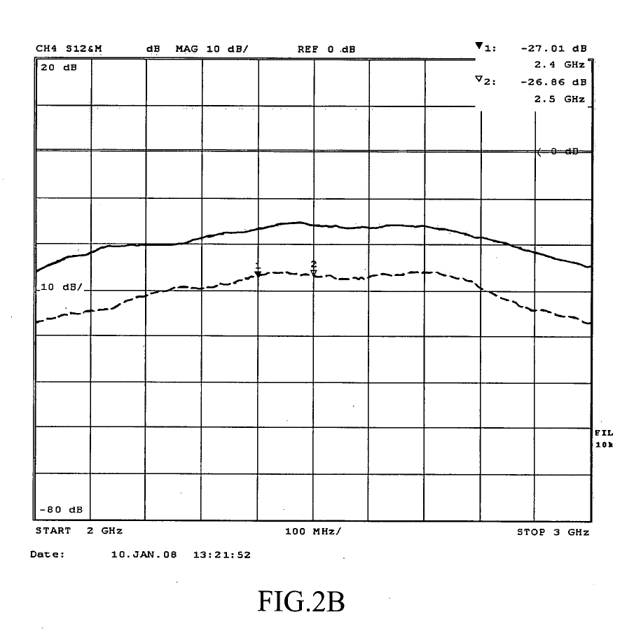

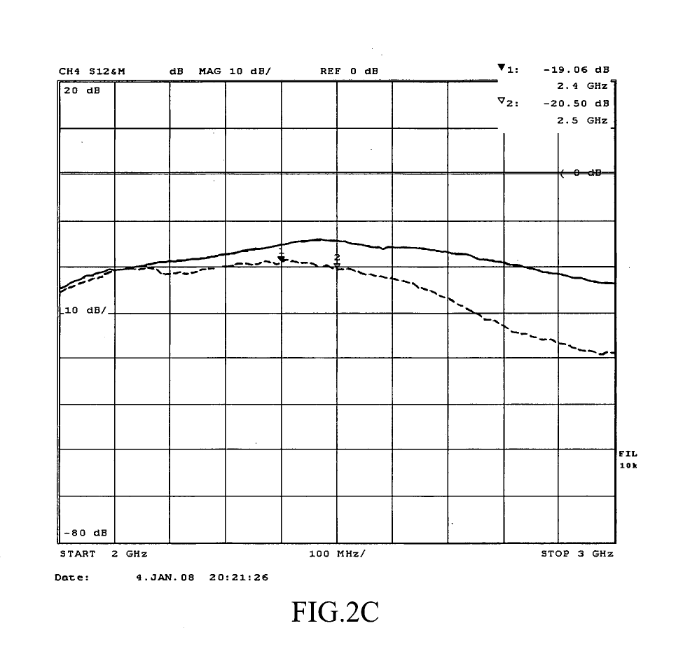

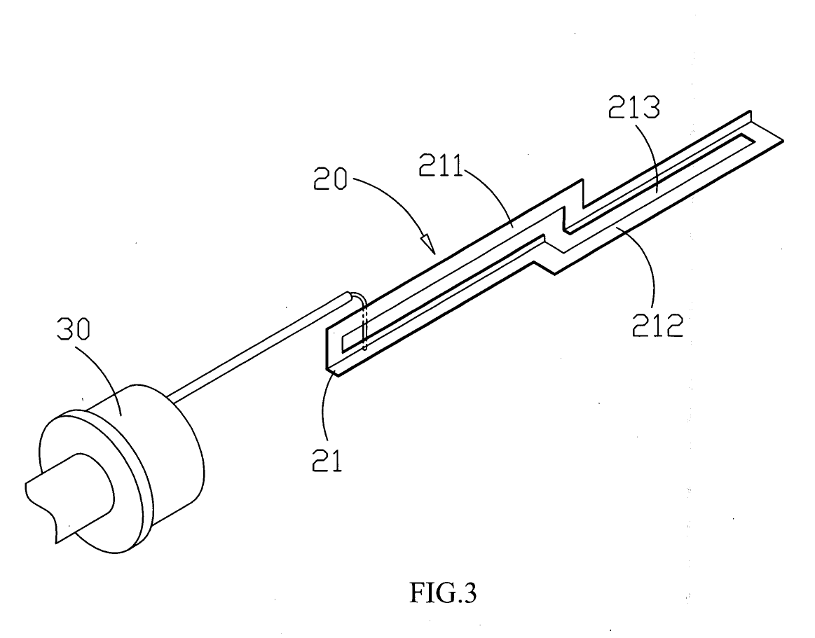

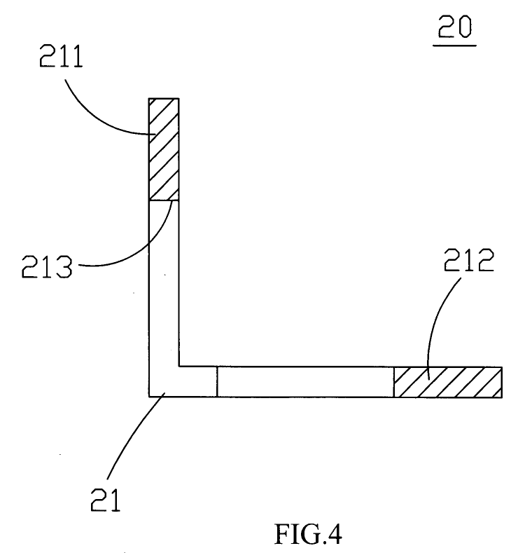

As shown in FIG. 2A, the antenna device of the invention comprises: a dipole antenna 10 and a slot antenna 20 which are respectively used for receiving and transmitting signals, wherein said slot antenna has at least one metal flat plate of L type section. Simultaneously referring to the first embodiment shown in FIG. 3 and FIG. 4, wherein slot antenna 20 is a metal flat plate of L type section 21 being made with a slot hole 213 thereon and being formed with a bending at middle section thereof, and two ends of said bending are respectively made to a vertically extended vertical section 211 and a horizontally extended horizontal section 212.

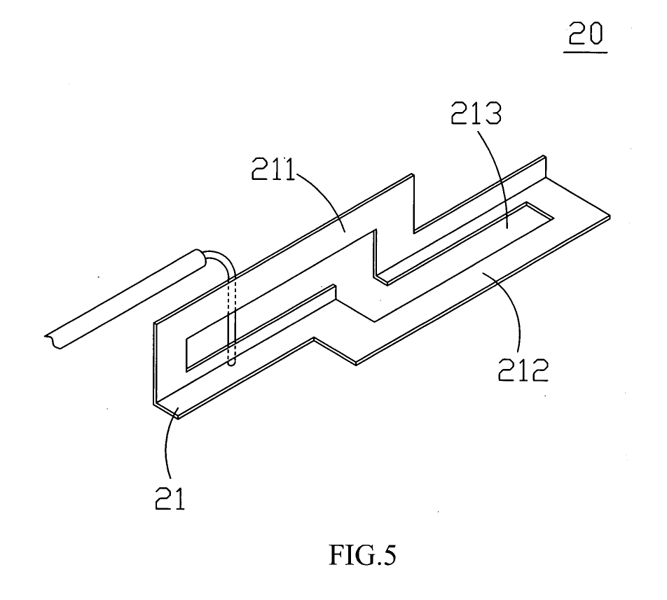

Said slot 213 of slot antenna 20 is connected through between vertical section 211 and horizontal section 212, thereby allowing one end of metal flat plate 21 to be used as the feed-in point for electrical connection with transmission wire 30. Further, as shown in FIG. 5, perimeter of slot 213 can be changed through changing the length of metal flat plate 21 to be matchingly used as a high frequency antenna (shorter slot perimeter) or low frequency antenna (longer slot perimeter).

As said dipole antenna and slot antenna of the invention are for receiving and transmission signals use, the reflection loss and voltage standing wave ratio (VSWR) of the dipole antenna and slot antenna are shown in FIG. 2B, wherein dipole antenna is represented by a solid line, and slot antenna in the first embodiment is represented by a dashed line, hence, as illustrated by the Fig., said dipole antenna and slot antenna can effectively segregate the receiving and transmission frequencies without causing signal interference due to the relatively larger cathode for better isolation, thereby constituting a multi-input, multi-output antenna device especially suitable for multi-input, multi-output (MIMO) use.

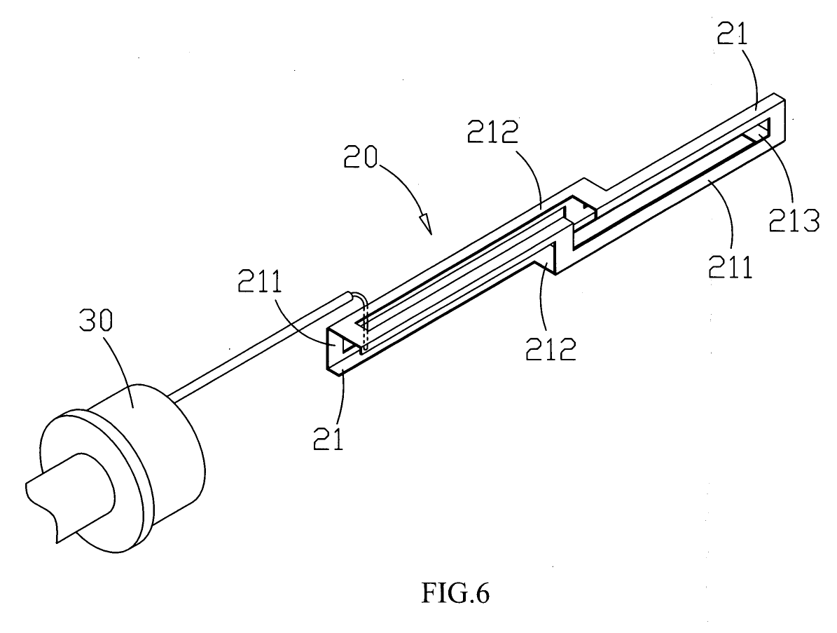

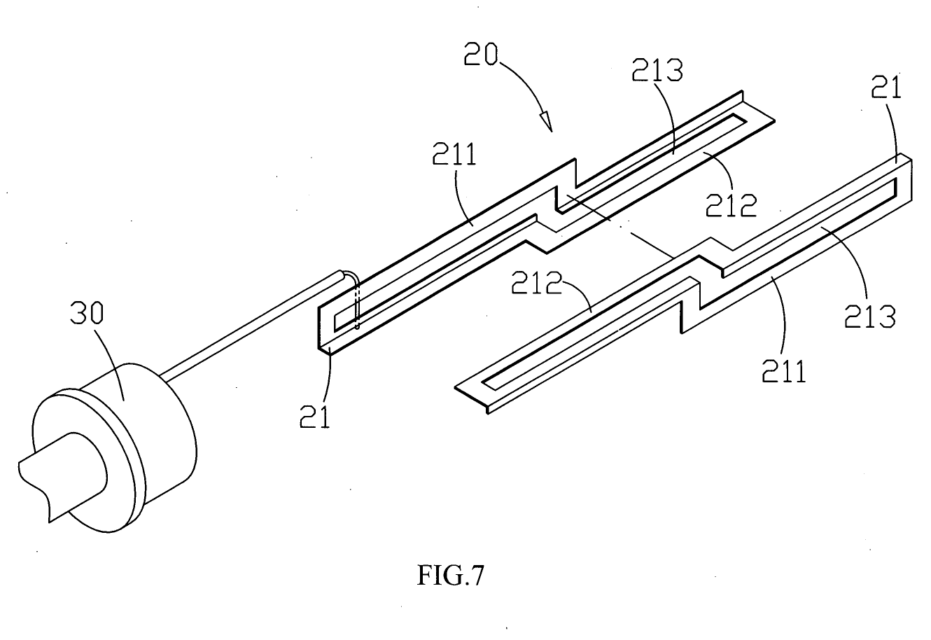

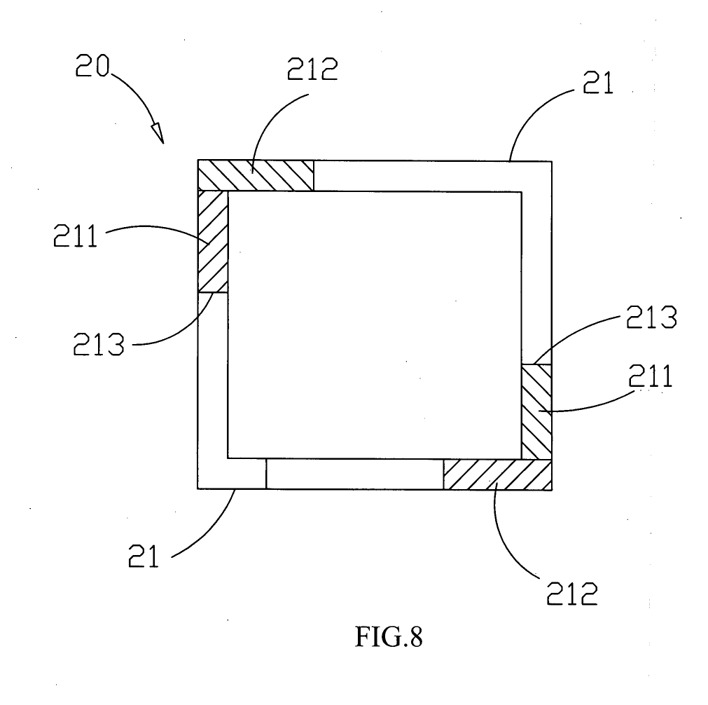

Furthermore, as shown by the second embodiment in FIGS. 6 to 8, said slot antenna 20 is constituted by two metal flat plates of L type sections 21 being mutually coveredly connected by welding, and each metal flat plate 21 is made with a slot 213 thereon and formed with a bending at middle section thereof, two ends of said bending are respectively made to a vertically extended vertical section 211 and a horizontally extended horizontal section 212.

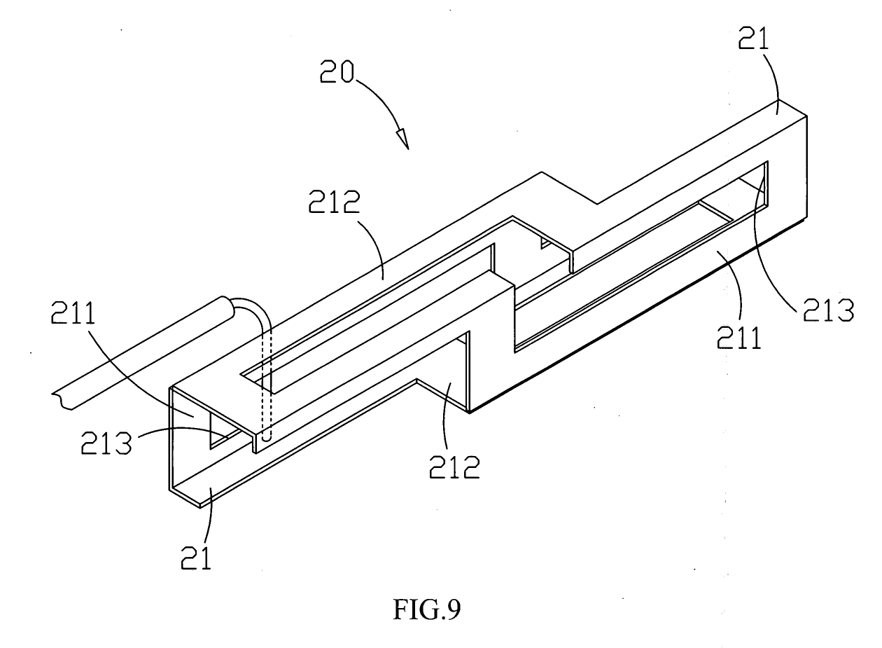

Said slot 213 of each metal flat plate 21 is connected through between vertical section 211 and horizontal section 212, thereby allowing one end of one metal flat plate 21 to be used as the feed-in point for electrical connection with transmission wire 30. Further, as shown in FIG. 9, perimeter of slot 213 can be changed through changing the length of metal flat plate 21 to be matchingly used as a high frequency antenna (shorter slot perimeter) or low frequency antenna (longer slot perimeter)

As said dipole antenna and slot antenna of the invention are for receiving and transmission signals use, the reflection loss and voltage standing wave ratio(VSWR) of the dipole antenna and slot antenna are shown in FIG. 2C, wherein dipole antenna is represented by a solid line, and slot antenna in the second embodiment is represented by a dashed line, hence, as illustrated by the Fig., said dipole antenna and slot antenna can effectively segregate the receiving and transmission frequencies without causing signal interference due to the relatively larger cathode for better isolation, thereby constituting a multi-input, multi-output antenna device especially suitable for multi-input, multi-output(MIMO) use.

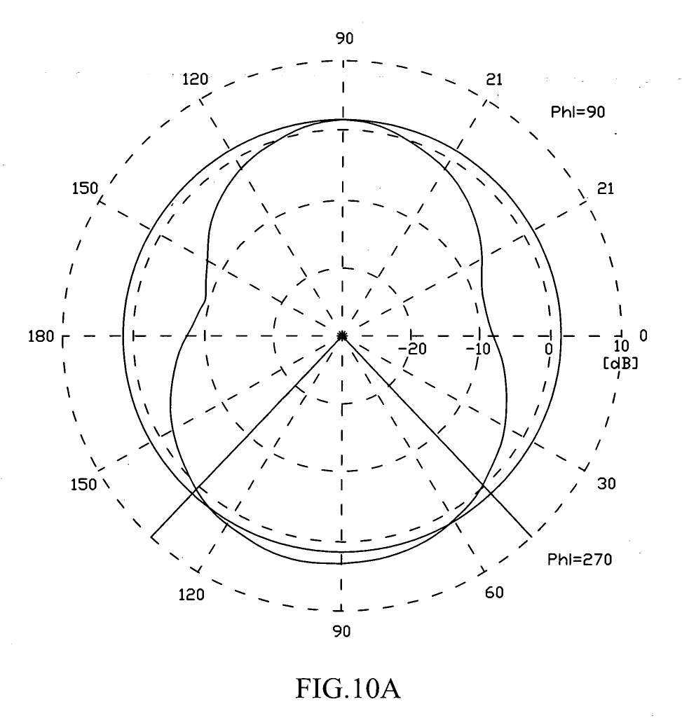

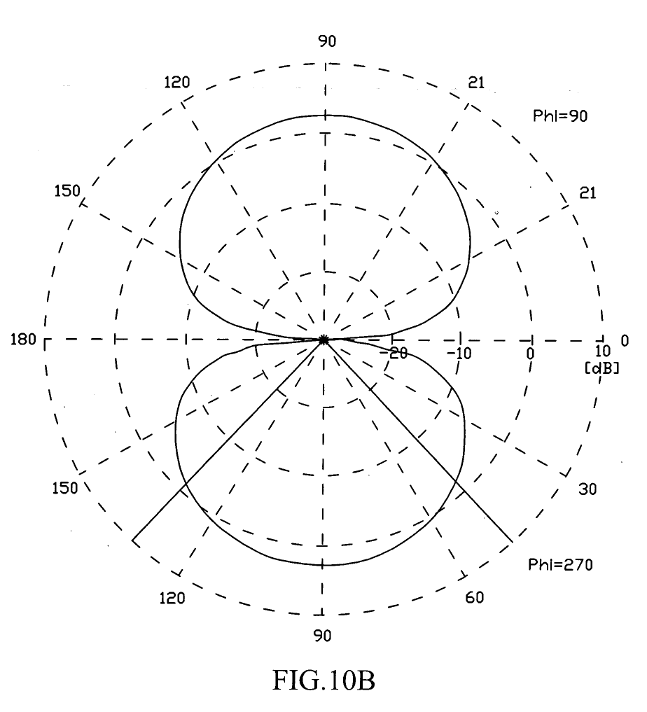

Additionally, FIG. 10A, 10B show the radiation field distributions measured at 2.45 GHZ frequency for said slot antenna of single slot in the first embodiment and said slot antenna of double slots in the second embodiment, wherein as shown in the Figs., said slot antenna of a single slot has a better directivity while said slot antenna of double slots has a better omni-directivity.

As summarized from above descriptions, the invention discloses a better and more practical multi-input, multi-output antenna device, hence it is applied for new type patent according to law. Further, as the contents and characteristics of the art has been disclosed above, while substitutions and modifications may be performed by those skilled in the art without deviating from the spirit of the invention due to disclosure of the invention. For this reason, scope of protection for this invention shall not be limited to the disclosed embodiments only, but shall also include the various substitutions and modifications without deviating from the spirit of the invention, and shall be covered by the scope of claims herein.

I claim:

1. A multi-input, multi-output antenna device comprising:
a dipole antenna;
a slot antenna has at least one metal flat plate of L type section being made with a slot thereon.

2. The multi-input, multi-output antenna device as claimed in claim 1, wherein said slot antenna has a metal flat plate of L type section being formed with a bending at middle section thereof, while two ends of said bending are respectively made to a vertically extended vertical section and a horizontally extended horizontal section and said slot is connected through between said vertical and horizontal sections.

3. The multi-input, multi-output antenna device as claimed in claim 2, wherein said slot antenna is through one end of metal flat plate be used as the feed-in point for electrical connection with transmission wire.

4. The multi-input, multi-output antenna device as claimed in claim 2, wherein perimeter of slot can be changed through changing the length of metal flat plate to be matchingly used as a high frequency antenna (shorter slot perimeter) or low frequency antenna (longer slot perimeter).

5. The multi-input, multi-output antenna device as claimed in claim 1, wherein said slot antenna is constituted by connecting two metal flat plates of L type sections, and each metal flat plate is made with a slot.

6. The multi-input, multi-output antenna device (II) as claimed in claim 5, wherein each metal flat plate is formed with a bending at middle section thereof, and two ends of said bending are respectively made to a vertically extended vertical section and a horizontally extended horizontal section, while slot of each metal flat plate is connected through between said vertical and horizontal sections.

7. The multi-input, multi-output antenna device as claimed in claim 5, wherein said slot antenna is constituted by two metal flat plates of L type sections being mutually coveredly connected.

8. The multi-input, multi-output antenna device as claimed in claim 5, wherein said slot antenna is constituted by two metal flat plates of L type sections being mutually coveredly connected by welding.

9. The multi-input, multi-output antenna device as claimed in claim 5, wherein said slot antenna is through one end of one metal flat plate to be used as the feed-in point for electrical connection with transmission wire.

10. The multi-input, multi-output antenna device as claimed in claim 5, wherein perimeter of slot can be changed through changing the length of metal flat plate to be matchingly used as a high frequency antenna (shorter slot perimeter) or low frequency antenna (longer slot perimeter).
